(19) United States
(12) Patent Application Publication
(10) Pub. No.: US 2026/0029975 A1
(43) Pub. Date: Jan. 29, 2026

(54) PROCESSING AND TRANSMITTING ACTIVE REGIONS OF DISPLAY FOR IMPROVED PERFORMANCE

(71) Applicant: Snap Inc., Santa Monica, CA (US)

(72) Inventor: Aaron L. Boyce, Camas, WA (US)

(21) Appl. No.: 19/270,225

(22) Filed: Jul. 15, 2025

Related U.S. Application Data
(60) Provisional application No. 63/674,383, filed on Jul. 23, 2024.

(51) Int. Cl. G06F 3/14; G06T 11/00

(52) U.S. Cl. CPC G06F 3/14; G06T 11/00

(57) ABSTRACT

A system is disclosed, including a display, a processor and a memory. The memory stores instructions that, when executed by the processor, configure the system to perform operations. Active region data is generated that includes, for each of one or more active regions, active region location data and active region content. The active region data is transmitted to a display having a display area. For each active region, the active region content is displayed at an active region location of the display area based on the active region location data, the active region content being displayed at a higher spatiotemporal information density than content displayed in the display area outside of the active regions.

### BACKGROUND

An electronic display typically requires pixel data to be transmitted to it at a pixel density and refresh rate that is uniform across the entire area of the display. In some contexts, this places a significant burden on the computational resources of the system controlling the display: generating and transmitting high pixel-density data at a high refresh rate requires a significant amount of power, data processing, and transmission bandwidth.

Augmented reality (AR) is an example of a context in which high pixel density and high refresh rates of displayed visual content are desirable, in order to present a natural appearance of virtual content displayed in combination with a real-world environment and to avoid artifacts such as motion blur. However, AR devices are often constrained in their computational resources (such as power, data processing, and data transmission bandwidth) due to their small size and the need to be worn or carried by a user.

Thus, it is desirable to provide efficient techniques for generation and transmission of visual content for display on an electronic display that overcomes one or more of the limitations described above.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a block diagram of a computing system configured to process, transmit, and display active regions of a display, according to some examples.

FIG. 2 is a block diagram of the active region rendering system of FIG. 1.

FIG. 3 is a block diagram of the display of FIG. 1.

FIG. 4 is a flowchart showing operations of a method for displaying content at active regions of a display, according to some examples.

FIG. 5 illustrates a first example display area of a display showing active regions, according to some examples.

FIG. 6 illustrates a second example display area of a display showing an active region encompassing overlapping active objects, according to some examples.

FIG. 7 illustrates a third example display area of a display showing active regions expanded based on display sectors, according to some examples.

FIG. 8 illustrates a first example transport frame encoding contiguous active region data by color, according to some examples.

FIG. 9 illustrates a second example transport frame encoding spaced apart active region data by color, according to some examples.

FIG. 10 illustrates a third example transport frame encoding active region data and updated active region location data by color, according to some examples.

FIG. 11 is a timing diagram of a further transport frame showing the timing of transmission of active region content once and active region location data four times per color, according to some examples.

FIG. 12 is a diagrammatic representation of a machine in the form of a computer system within which a set of instructions may be executed to cause the machine to perform any one or more of the methodologies discussed herein, according to some examples.

FIG. 13 is a block diagram showing a software architecture within which examples may be implemented.

### DETAILED DESCRIPTION

Examples are described herein that provide techniques for processing and transmitting visual content corresponding to active regions of a display. An active region of a display is a region in which content is changing more rapidly than in non-active regions (also called inactive regions). In some examples, such as certain AR displays, the active regions of the display are the only regions where non-black pixel values are displayed: for example, an optical see-through AR headset display may permit the wearer to see through to the real world in most display regions without overlaying virtual content in those regions, with only a small portion of the display being occupied by non-black pixels presenting virtual objects. However, the regions occupied by these virtual objects may benefit from being displayed at a higher resolution to provide a high pixel density, thereby simulating a realistic appearance, and/or at a high refresh rate (also referred to as a frame rate) in order to avoid artifacts such as motion blur when the object moves or when the user's head moves, thereby causing the virtual object to be presented at a different display location in a subsequent frame. In some examples, a stereoscopic AR headset display may benefit from displaying virtual objects at a resolution of 4 megapixels (Mpix) per eye, covering a field of view (FOV) of 50 degrees per eye, at a refresh rate of 120 Hz. The computational and power requirements of displaying content across the entire area of each display at these resolutions and refresh rates is considerable, and may be beyond the capability of small, lightweight head mounted devices. Offloading the computation to a separate device similarly raises concerns of transmission bandwidth to the displays, particularly over wireless links.

In order to address these limitations, examples described herein display content at active regions of the display (e.g., regions corresponding to virtual objects) at a higher spatiotemporal density than content displayed at inactive regions. As used herein, the term “higher spatiotemporal density” refers to a higher resolution, a higher pixel density (e.g., pixels per degree of FOV), a higher refresh rate, and/or a combination thereof. In some examples, a higher spatiotemporal density indicates a higher product of pixel density times refresh rate. For example, a measure of spatiotemporal density may be pixels per degree of field of view, per second (pixel density times refresh rate). Another measure of spatiotemporal density may be pixels per inch per second. Other suitable measures of spatiotemporal density can be used in some examples, as will be appreciated by a skilled person. Because spatiotemporal density is typically proportional to a data rate for generating and transmitting visual data, high spatiotemporal density for active regions constituting only a portion of the display area of a display may result decreased requirements for processing and transmitting visual data relative to techniques displaying content at high spatiotemporal density across an entire display.

Thus, examples described herein attempt to address one or more of the technical problems described above. First, by displaying content at a high spatiotemporal density only within the active regions, the computational load on the computing system processing and rendering the visual content may be reduced. Second, by displaying content at a high spatiotemporal density only within the active regions, the power requirements on the computing system processing and rendering the visual content may be reduced. Third, by displaying content at a high spatiotemporal density only within the active regions, the transmission bandwidth or capacity requirements between the computing system and the display may be reduced. Alternatively, seen from the opposite perspective, the spatiotemporal density (e.g., resolution, pixel density, and/or refresh rate) of the content displayed at the active regions may be increased while staying within the computational, power, and transmission capacity constraints of the system. Thus, in some examples, small regions of virtual content may be displayed at a high refresh rate and a high pixel density, thereby providing a realistic appearance and avoiding artifacts such as motion blur or flicker, even when using a computing system having limited computing, power, and/or data transmission capacities.

In summary: some AR headset users and designers present a demanding set of requirements for AR displays. The display for each eye of a stereoscopic AR device should have many pixels to support a wide FOV with retina-level resolution, such as 4 megapixels per eye. Virtual objects should be presented on the displays to appear stable and locked to the 3D physical environment in the context of a headset that in many cases is constantly moving with the wearer's head. Moving virtual objects should be presented with high fidelity, which usually requires high frame rates of 120 Hz or more. The conventional render-and-display approach to AR displays demands high data bandwidth to the display and high compute resources to support it, both of which drive increased power and cost.

However, in a typical AR use case, the conventional render-and-display approach is highly wasteful. First, in an optical see-through AR device, most of the pixels are black (e.g., not illuminated) to provide transparency to the real world; the active pixels presenting virtual overlay information are very sparse over the display area of the display. Second, a high frame rate (e.g., 120 Hz) is only needed for motion compensation (to improve pixel placement accuracy) and to avoid flicker; the updating of the rendered content itself is typically satisfactory at a lower refresh rate (e.g., 30 Hz).

In order to address those desired features while avoiding power, compute, and bandwidth limitations, some examples described herein provide a system having a display that is more involved in the rendering process than in the conventional approach, as well as an intelligent interface to the display. In some examples, the data transmitted to the display updates the content of the active regions of the display only when they change. The display moves the active regions to their updated locations for motion compensation at a faster refresh rate using a simple metadata scheme for position control. This approach may reduce the data bandwidth to the display and lets the computing system process and render visual content at a much lower frame rate, thereby conserving computing resources at the computing system and saving power at both the computing system and the display.

Example use cases for the examples described herein include AR displays, such as stereoscopic optical see-through head-mounted AR displays. Newer AR headsets may offer 50 degrees of FOV on the diagonal per eye, with an overlapped or shared FOV for both eyes, and may use a pixel density of 40-50 pixels per degree (ppd), approaching the foveal retina resolution of 60 ppd. In contrast, virtual reality (VR) headsets commonly offer 100+ degrees FOV with areas unique per eye, but use a lower pixel density of approximately 20 ppd. Both the AR example and the VR example commonly use 1920×1080 pixel displays, resulting in a resolution of approximately 2 Mpix/eye. Because combining both high FOV and high pixel density is difficult if not impossible for today's headsets, the AR and VR cases make trade-offs in prioritizing one goal or the other due to the different optical constraints and requirements of each use case.

However, some examples described herein may enable the operation of higher pixel count displays than the AR and VR use cases described above. In some examples, a 50 degree FOV device with 60 ppd, requiring 3000 pixels on the diagonal, could be implemented using a 2048×2048 pixel display (about 2900 pixels on the diagonal) having a total resolution of approximately 4 Mpix. The computing, power, and transmission bandwidth requirements to drive such as display (or a pair of such displays) could be reduced in some examples by adopting techniques described herein.

Currently, most AR and VR systems only provide approximately 2 Mpix per eye, which is not only the maximum resolution of the displays used, but is also near the limit that can be processed by the computing systems of the VR and AR systems at the needed frame rates. However, much of that processing is wasted because of the sparse nature of AR use cases. The active pixels that need to be refreshed at a high rate are often well under 25% of the display area, but the conventional approach must render and transmit the entire display area. Examples described herein only render and transmit the active pixels, which account for only approximately 1 Mpix (25% of a 4 Mpix display).

Frame Rates (FR) or refresh rates for VR sets are typically 90 Hz or better. Some AR sets are 120 Hz, but most are lower to deal with compute limitations. Many AR sets use color sequential displays, which typically set the color sub-frame rate at 3 times the overall refresh rate for a 3-color (e.g., RGB) display. Typically, display systems keep the refresh rate at 60 Hz or higher to stay above the human flicker perception. However, frame rate for movies or other video content is commonly sourced at only 48 Hz and then displayed at 60 or 96 Hz using frame interpolation; similarly, some gaming systems source video at 30 Hz and display at much higher rates to implement motion compensation as the user's point of view changes.

To keep power and weight to a minimum, head mounted displays usually don't interpolate or scale the input video. Instead, the video source (e.g., the computing system processing and rendering the visual content) must provide the video at the desired refresh rate, within the limits of the display's capability. However, some examples described herein may provide displays having more intelligent interfaces to bridge the gap of low frame rates for rendering (e.g., the content need only be rendered at a relatively low rate, such as 30 Hz, by the computing system) and high refresh rates for precise motion control (e.g., the location(s) of the content within the display area can be updated at a higher refresh rate, such as 120 Hz, by the display).

Thus, some examples may additionally attempt to address the technical problem of motion compensation by rendering and transmitting the visual content to the display at a relatively low frame rate (such as 30 Hz), and then updating the location of the content within the display area of the display at a higher refresh rate (such as 120 Hz). Because the location data required to update the display location of content is much lower-bandwidth and less computationally expensive to generate and transmit than the content itself, the location data can be generated, transmitted, and used to update the content location at a much higher rate than the frame rate of the content at a modest increase in computational, power, and data transmission load. This may reduce the computation, power, and transmission bandwidth requirements for processing and transmitting visual content while maintaining a high refresh rate to avoid artifacts such as flickering and motion blur.

### Computing System

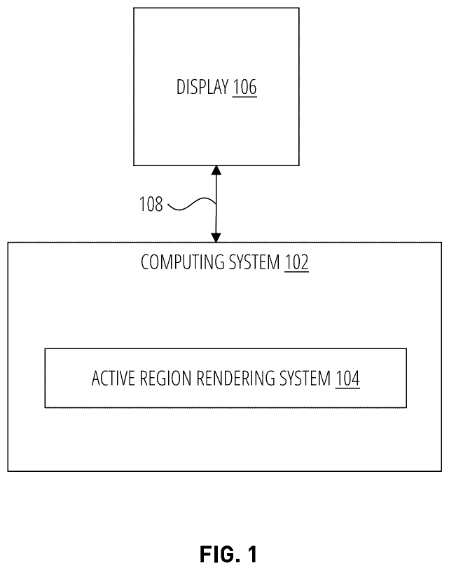

FIG. 1 shows a block diagram of a computing system 102 configured to process, transmit, and display active regions of a display 106. In some examples, the display 106 is considered part of the computing system 102. In some examples, the display 106 and computing system 102 system are components of a larger system.

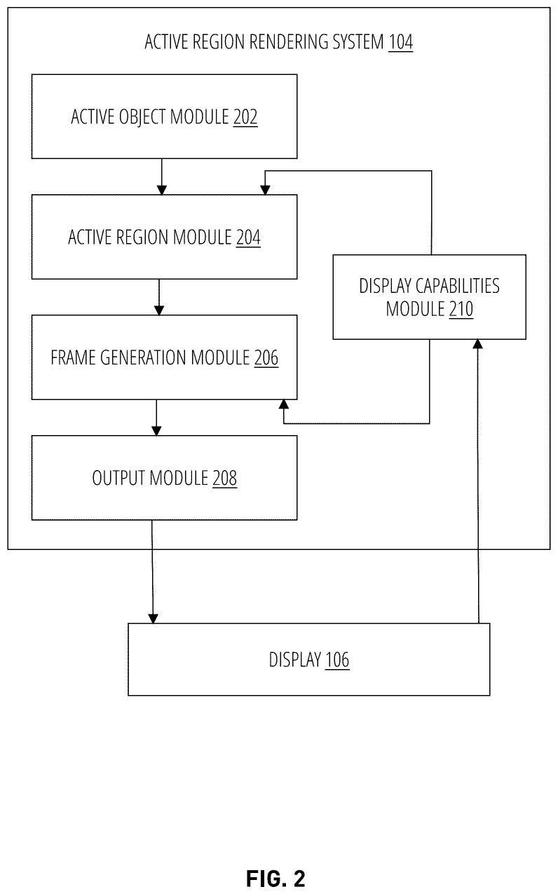

The computing system 102 includes an active region rendering system 104 and a communication link 108. The active region rendering system 104 is configured to process, render, and transmit visual content to the display 106, as described in greater detail below with reference to FIG. 2 through FIG. 11.

The communication link 108 is used to transmit display data (such as transport frames containing active region data, described below) to the display 106, and may be used in some examples to receive display hardware data indicating information about the display 106, such as its hardware configuration and/or supported display formats (e.g., refresh rates, pixel densities, resolutions). In some examples, the display hardware data may include Extended Display Identification Data (EDID). In some examples, the display hardware data is communicated as part of a handshake protocol similar to an EDID handshake. The communication link 108 can be implemented by any suitable wired or wireless communication technology, such as a data bus or a high speed digital link (such as USB-C, HDMI, etc.).

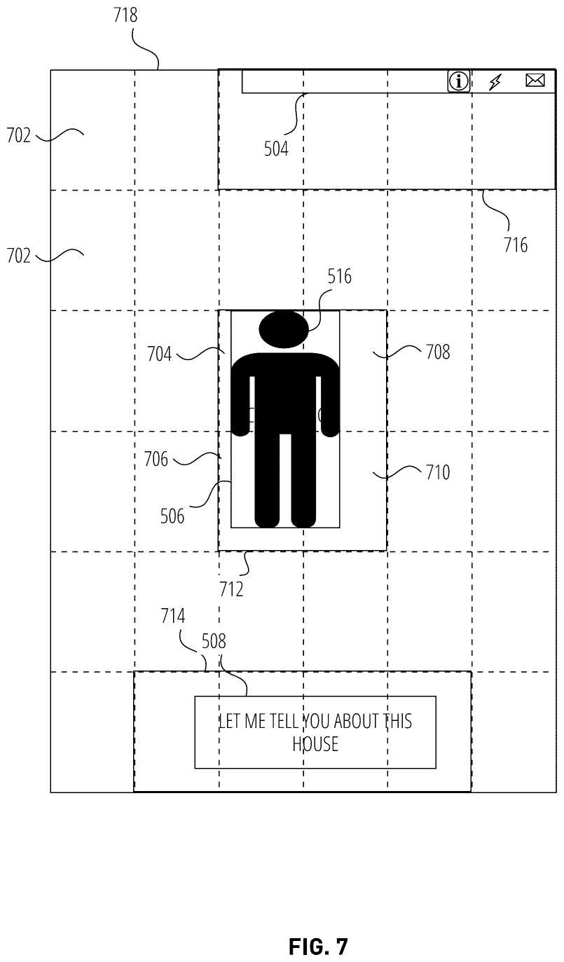

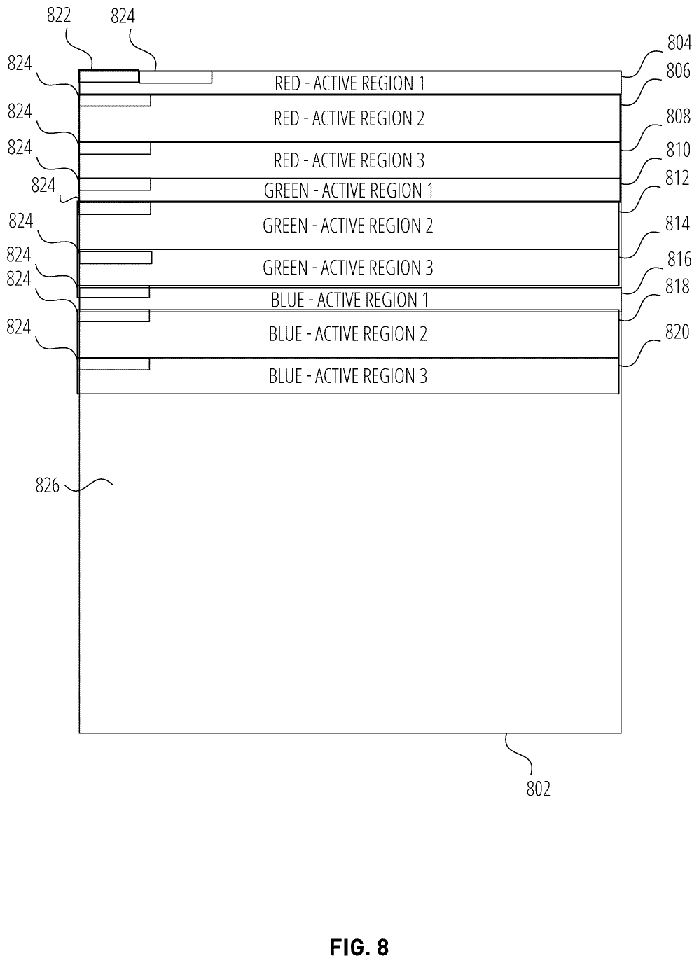

In some examples, the display 106 is configured to receive data from the computing system 102 and present content on a display area of the display 106 in accordance with examples described herein. For example, some displays may be configured to display content in different display locations during different frames or sub-frames as described below with reference to FIG. 8 through FIG. 11 below. Some displays 106 may be configured to update or refresh portions of their display area on a sector-by-sector basis, as described below with reference to FIG. 7 below. It will be appreciated that, in various examples, both the display 106 and the interface between computing system 102 and display 106 are configured to present visual content in accordance with the techniques described herein.

It will be appreciated that examples described herein as using a display, such as display 106, can include more than one display, such as two displays for presenting a stereoscopic view to a user. Techniques described herein are equally applicable to systems using two or more displays as those systems using a single display.

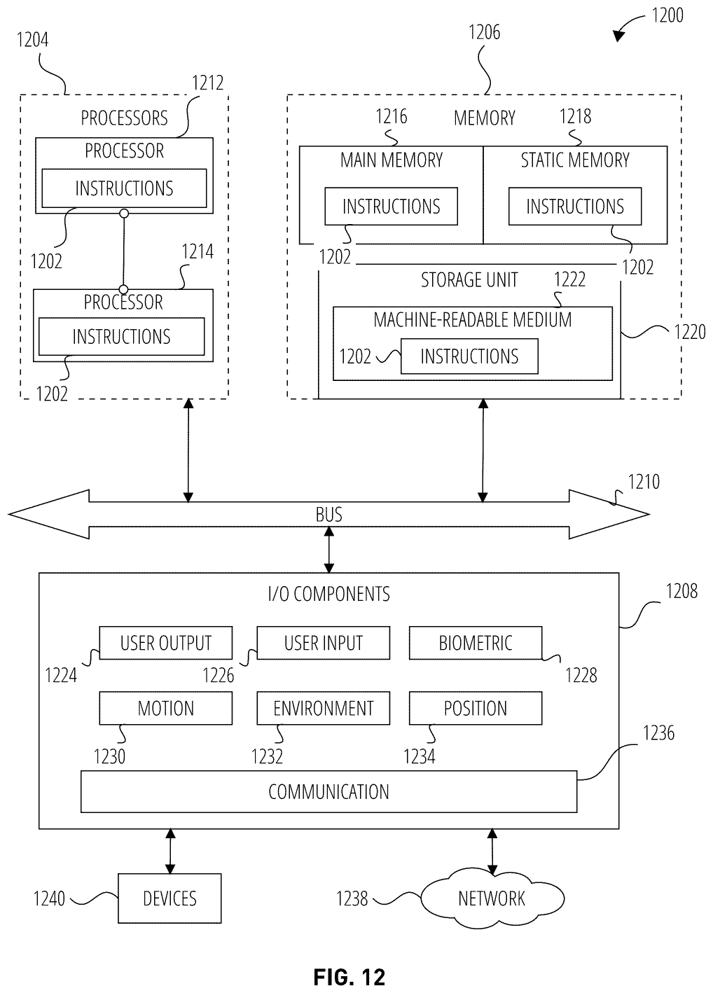

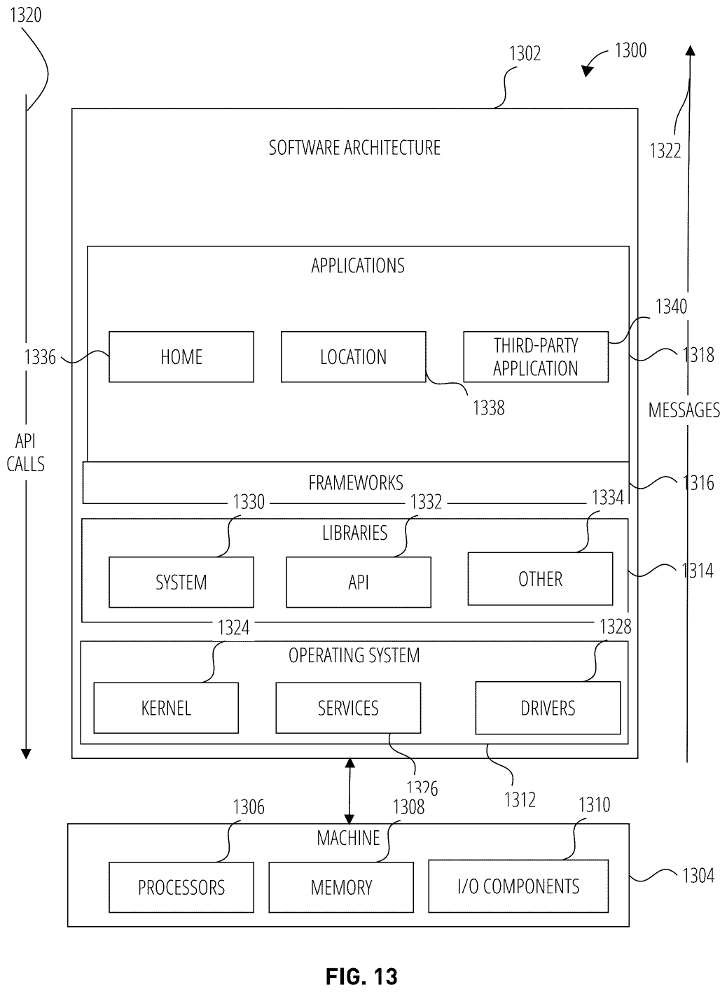

In some examples, the computing system 102, including the active region rendering system 104, is implemented by a machine 1200 and software architecture 1302 as described in FIG. 12 and FIG. 13 below. The display 106 can be implemented using some combination of hardware and software (e.g., firmware) logic to process the data received from the computing system 102 (such as the transport frames described below in FIG. 8 through FIG. 11) and present the processed visual content on the display area of the display 106. It will be appreciated that the computing system 102, active region rendering system 104, communication link 108, and display 106 can be implemented using other suitable means in other examples.

### Active Region Rendering System

FIG. 2 is a block diagram of the active region display system of FIG. 1. It will be appreciated that various additional functional components may be supported by the active region rendering system 104 to facilitate additional functionality that is not specifically described herein. The various functional modules depicted in FIG. 2 may reside on a single computing device or may be distributed across several computing devices in various arrangements.

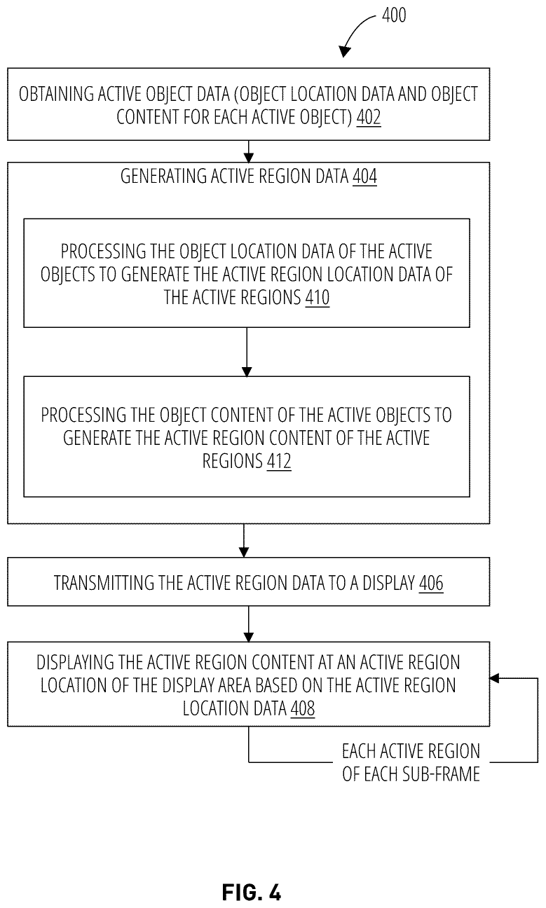

As shown, the active region rendering system 104 includes an active object module 202, an active region module 204, a frame generation module 206, an output module 208, and a display capabilities module 210. The operation of these modules in various examples is described in detail below with reference to FIG. 4 through FIG. 11. However, a functional summary of these modules is described immediately below.

The active object module 202 is configured to obtain active object data corresponding to one or more active objects. An active object is an object that may potentially be displayed on the display 106, such as a virtual object for display on an AR display or a conventional 2D element such as a graphical user interface (GUI) element (e.g., an icon, a window, a panel, etc.). Some examples described herein are intended to display active objects over a portion of the display area of the display 106, while the rest of the display area of the display 106 remains blank (e.g., displaying black pixels) or otherwise static. The active object data includes, for each active object, object location data representative of a location of the active object and object content representative of the visual content of the active object. For example, an active object corresponding to a GUI window may be represented by object location data indicating screen coordinates (e.g., a horizontal and vertical offset from the top left corner of the display area) and window dimensions (e.g., 500 horizontal pixels and 350 vertical pixels). The object content of the GUI window active object may consist of pixel color values for the pixels included within the window dimensions. In another example, an active object corresponding to a 3D virtual object associated with a 3D location in the physical environment may be represented by object location data indicating the location and dimensions of a 2D or 3D rectangular bounding box, in 2D or 3D space. In the case of 3D active objects, the active object module 202 operates to process the 3D object location data along with position data indicating the point of view of the user relative to the 3D space and project or transform the 3D active object location data onto the 2D display area of the display 106. (In the case of stereoscopic or other multi-display systems, this transformation is performed for each display based on the corresponding point of view for each of the user's eyes or another suitable point of view for each display.)

The active region module 204 processes the 2D object location data obtained and/or generated by the active object module 202 to generate active region location data for one or more active regions of the display area of the display 106. The object content of the active objects is then processed by the active region module 204 to generate active region content for display within the active regions. The active region location data and active region content are jointly referred to as active region data.

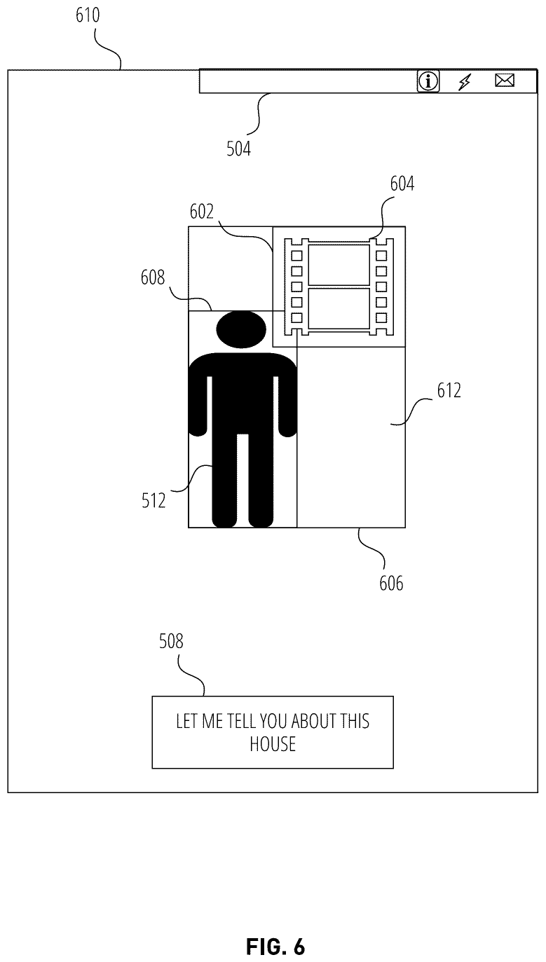

The active region module 204 may operate differently in different examples, based on the design of the active region rendering system 104 and/or the capabilities of the display 106 being used. In some examples, the active regions are rectangular. In some examples, two or more overlapping active object locations result in the generation of a single active region encompassing the overlapping active objects, as described below with reference to FIG. 6. In some examples, the active regions may be expanded to encompass the entire area of one or more sectors of the display area, as described below with reference to FIG. 7.

The operation of the active region module 204 functionally divides the display area of the display, at each frame and/or sub-frame, into one or more active regions and one or more inactive regions. In some examples, the inactive regions are updated at a lower frame rate and/or lower refresh rate than the active regions. In some examples, the inactive regions are configured at a lower resolution and/or lower pixel density than the active regions, such that the inactive regions may be rendered and/or displayed as matrices of macropixels, i.e., pixel color values mapped to multiple physical pixels or regions of the user's field of view encompassing the same FOV area or angle as multiple pixels in the active regions. In some examples, a macropixel may correspond to an area or angle that would be occupied by a square or non-square-shaped set of pixels in an active region, such as a 2×2, 4×4, or 8×8 matrix of pixels. In some examples, the inactive regions do not have any content displayed within them, e.g., they display only blank or black pixels. This may be regarded as content having zero spatiotemporal density, having a resolution and refresh rate of zero.

In some examples, each active region in a frame or subframe is updated and displayed at the same resolution, pixel density, frame rate, and refresh rate. In other examples, different active regions may be updated and/or displayed at different resolutions, pixel densities, frame rates, and/or refresh rates.

In some examples, the various active regions may be configured to be displayed at different pixel densities and/or refresh rates based at least in part on the location of the active region in relation to a central region of the display area. For example, a foveated display system may be implemented by displaying active regions close to the center of the FOV of the user (e.g., close to the center of the display area) at a higher pixel density than regions in the periphery of the display area. In practice, many users of head-mounted stereoscopic displays tend to orient their heads such that the FOV of the head-mounted device is centered on the object or region of space that the user is visually attending to, particularly with respect to horizontal coordinates (i.e., left to right) in the center of the display. Thus, by displaying active regions near to the center of the display area at a high pixel density relative to lower pixel density regions near the periphery of the display area (e.g., using macropixels of 2×2 or 4×4 display pixels to display the content in these peripheral active regions), a foveated effect can be created wherein the content most likely to be attended to by the user is displayed at a higher resolution (and/or a higher refresh rate in some examples).

In some examples, the active object module 202 may be omitted, and the active region data may be generated directly by the active region module 204, for example, based on data received from a GUI subsystem. Similarly, in some examples, the functions of one or more of the modules shown in FIG. 2 may be combined in a single module, split up among two or more modules, or distributed differently among the various modules.

The frame generation module 206 processes the active region data generated by the active region module 204 to generate transport frames encoding the active region data. Various schemes for encoding active region data in transport frames are described below with reference to FIG. 8 through FIG. 11. In general terms, a transport frame encodes active region content for a single frame of a sequence of frames, and transport frames are generated and transmitted to the display at a frame rate (e.g., 30 Hz) of the active region content. However, in some examples the transport frames also include two or more instances of the active region location data encoded as sub-frame headers, such that the location of each active region is updated one or more times during the frame to achieve a higher refresh rate (e.g., 120 Hz) for the active region locations. The higher refresh rate for the active region locations may perform motion compensation to mitigate or eliminate motion artifacts, while the relatively lower frame rate for updating the inactive region content satisfies the requirements for realistic appearance while reducing the computational and data transmission load on the computing system 102 and communication link 108.

The output module 208 transmits the active region data, encoded in the transport frames, to the display 106. The output module 208 includes an output interface to the display 106 in some examples.

The display capabilities module 210 includes an input interface for receiving data, such as display hardware data, from the display 106, as described above. In some examples, the display hardware data regarding the capabilities and configuration of the display 106, may be provided to the active region module 204 and/or the frame generation module 206 for use in generating the active region data and/or transport frames. In some examples, a handshake protocol is used to obtain basic features of the communication link 108 and/or display 106, and a different protocol is used to determine the supported features or capabilities of the display 106 related to the active region techniques described herein, and/or to determine how to encode the active region data. In some examples, the active region location data can be sent as packets in the blanking portions of a communication protocol used over the communication link 108.

The display 106 decodes the transport frames to display the active region content in the active region locations. During each frame (and, in some examples, each sub-frame), the display 106 displays, for each active region, the active region content at an active region location of the display area based on the active region location data. The active region content is displayed at a higher spatiotemporal information density than content displayed in the display area outside of the active regions (i.e., the inactive regions). In some examples, the decoding and display of the active regions.

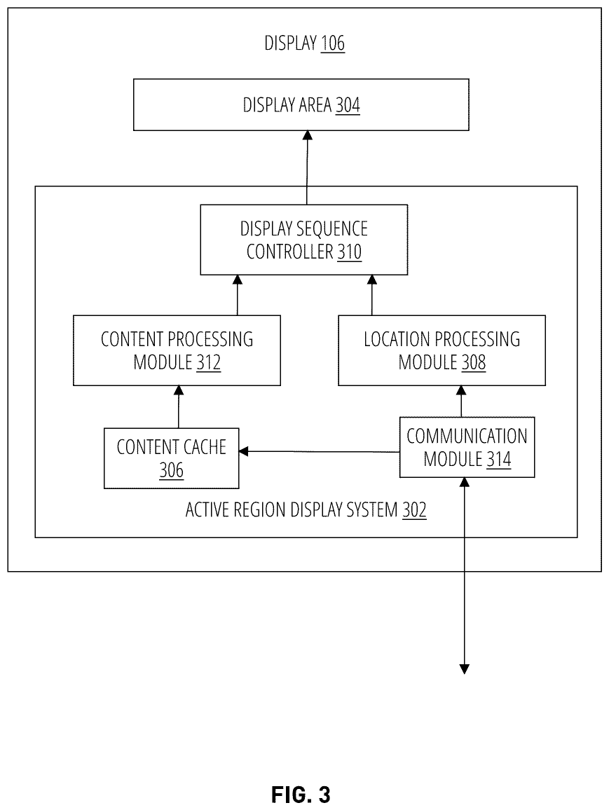

FIG. 3 is a block diagram showing the functional modules of an example display 106 configured to implement some examples described herein. The example display 106 is a smart display device configured to decode active region data generated by the active region rendering system 104 and cause the active region content to be displayed on a display area 304 of the display 106. To perform the processing of the active region data, the display 106 includes an active region display system 302, including a content cache 306, a location processing module 308, a display sequence controller 310, a content processing module 312, and a communication module 314. These various components may be implemented using a suitable combination of hardware elements and, optionally, software (e.g., firmware) elements.

The communication module 314 is configured to receive the active region data from the communication link 108 (e.g., in the form of a sequence of transport frames, as described below). The communication module 314 may also be configured to send, over the communication link 108, data representative of the capabilities of the display 106 (e.g., display hardware data and/or data indicating supported protocols or techniques for active region data communication and processing).

The location processing module 308 is configured to decode or otherwise obtain the active region location data from the received active region data (e.g., from sub-frame headers of the transport frames, as described below). The location processing module 308 processes the active region location data and provides the processed output to the display sequence controller 310 to enable the display sequence controller 310 to display active region content on pixels of the display area 304 corresponding to the active region location data. In some examples, the location processing module 308 decodes parameters from the active region data that indicate pixel densities and/or refresh rates of various active regions, which are used in formatting the output to the display sequence controller 310 to enable the pixels of the display area 304 to be written with the content at the appropriate pixel density and/or at the appropriate period during the frame time.

The content cache 306 decodes or otherwise obtains the active region content from the received active region data (e.g., from the sub-frames of the transport frames, as described below). The cached content is provided to the content processing module 312 at the proper time during the frame time of the display 106 to enable the content to be written to the pixels of the display area 304.

The content processing module 312 processes the content from the content cache 306 to generate an output signal to the display sequence controller 310 that enable the content to be written to the pixels of the display area 304. For example, in some examples the content may be decoded and formatted into rows of pixels for output to the display sequence controller 310.

The display sequence controller 310 is configured to write pixel values to the display area 304 at pixel locations and during time periods during the frame time according to the inputs received from the content processing module 312 and location processing module 308.

In some examples, the pixel density designated for a region allows the pixels of the region to be written in segments or sectors based on the pixel density of the region. For example, if a given region has a pixel density indicating the use of macropixels consisting of 4×4 pixel arrays, then four adjacent rows of that region may be written at a time with the same value, which may significantly improve efficiency. Similarly, efficiency can be increased by clearing or blanking the remainder of a row that is in an inactive region, by clearing or blanking rows that are within the first region in a frame to be written, and/or by clearing or blanking the entire display area 304 to erase stale active region content when the active region(s) have moved to a new location. In some examples, the rendering of the active region content is constrained by sectors of the display area 304, as described in greater detail below with reference to FIG. 7; in some such examples, efficiency may be increased by processing the content for every active sector of the display area 304 within a rendering operation, instead of first rendering active region content and then, in a second operation, mapping the active region content to one or more sectors.

Whereas the examples described herein refer to the processing and rendering of pixel-level values within the active region display system 302, it will be appreciated that some examples may embed additional logic in the display area 304 itself to perform additional processing of the pixel data received from the display sequence controller 310. For example, the display area 304 may include an additional ASIC or other hardware logic configured to operate in an active region mode in which some of the pixel values sent by the display sequence controller 310 encode header data specifying where to display the other pixel data, e.g. which pixel rows are active rows. For example, in some examples the active region display system 302 may expand the received frame headers and sub-frame headers and write an expanded header into the content cache 306, which is then retrieved by the display sequence controller 310 and used to instruct the display area 304. In some examples, the logic of the 304 may be configurable to operate in either a legacy mode (without the use of active regions, interpreting all pixel data as pixel content) or an active region mode as described above.

Examples of active region location data processed by the display 106, in the form of transport frames, are described below with reference to FIG. 8 to FIG. 11.

It will be appreciated that, in some examples, the various functions of the active region display system 302 may be implemented by one or more devices that are not part of the display 106 itself.

### Method for Displaying Content at Active Regions of A Display

FIG. 4 shows operations of an example method 400 for processing, transmitting, and displaying content at active regions of a display. The method 400 provides an example of how the active region rendering system 104 and display 106 cooperate to generate and present visual content in the active regions of the display 106. Whereas the examples described herein implement the operations of method 400 using the active region rendering system 104, display 106, and computing system 102 of FIG. 2, it will be appreciated that some example methods can be implemented using other suitable means.

Although the example method 400 depicts a particular sequence of operations, the sequence may be altered without departing from the scope of the present disclosure. For example, some of the operations depicted may be performed in parallel or in a different sequence that does not materially affect the function of the method 400. In other examples, different components of an example device or system that implements the method 400 may perform functions at substantially the same time or in a specific sequence.

According to some examples, the method 400 includes obtaining active object data at operation 402. The active object data includes object location data and object content for each active object, as described above. The active object data is received, generated, and/or otherwise obtained by the active object module 202.

According to some examples, the method 400 includes generating active region data at operation 404. The active region data includes active region location data and active region content for each active region. In some examples, the active region data is generated by processing the object location data of the active objects to generate the active region location data at operation 410, and processing the object content of the active objects to generate the active region content of the active regions at operation 412. The active region data is generated by the active region module 204.

According to some examples, the method 400 includes transmitting the active region data to the display 106 at operation 406. In some examples, the active region data is encoded in a sequence of one or more transport frames by the frame generation module 206, each transport frame encoding active region content for each active region in the frame and at least one active region location for each active region in the frame, as described in greater detail below with reference to FIG. 8 through FIG. 11. The transport frames are then transmitted by the output module 208, via the communication link 108, to the display 106. In some examples, the transport frames are transmitted in the same sequential order in which they are to be displayed.

According to some examples, the method includes displaying the active region content at an active region location of the display area of the display 106 based on the active region location data at operation 408. The display 106 decodes the active region location data from a transport frame (e.g., from the sub-frame headers of a transport frame according to FIG. 8 through FIG. 10 below), decodes the active region content from the transport frame (e.g., from the content of each sub-frame), and displays the active region content (e.g., of each sub-frame) at the active region location.

In some examples, operation 408 is repeated for one or more additional active regions of one or more sub-frames within the transport frame, as described below with reference to FIG. 8 through FIG. 11.

After all the active regions have been displayed and updated throughout the frame based on the transport frame, another transport frame is received and used to display the active region content. In some examples, the operations taking place at the computing system 102 (e.g., operations 402, 404, and 406) are performed in parallel and concurrently with the operations performed at the display 106.

### Display Areas Showing Active Regions

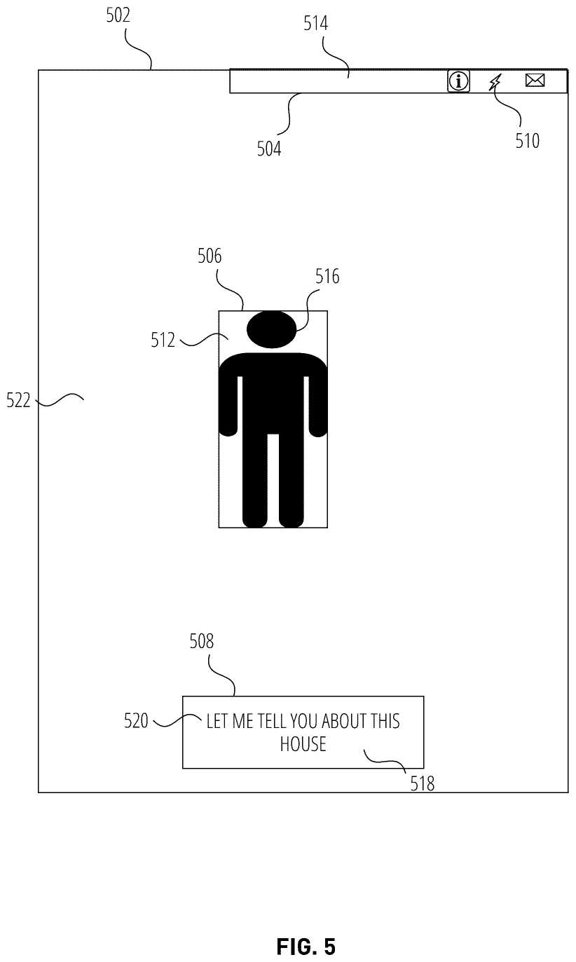

FIG. 5 illustrates a first example display area 502 of a display 106 showing three active regions, each corresponding to a single active object. A first active object 514 defines a first active region, located at a first active region location 504 at the top right corner of the display area 502, shown as a status bar displaying a row of icons as the first active region content 510. A second active object 516 defines a second active region, located at a second active region location 506, shown as a virtual avatar associated with a 3D location in the physical environment as the second active region content 512. In the described example, the virtual avatar of the second active object 516 acts as a tour guide to narrate a guided tour through a house. A third active object 518 defines a third active region, located at a third active region location 508, shown as a textual caption (e.g., “Let me tell you about this house . . . ”) as the third active region content 520. In the described example, the third active object corresponds to the narration delivered by the virtual avatar.

It will be appreciated that the three active region locations 504, 506, 508 occupy a small portion of the display area. For example, the entire display area 502 may be 2048×2048 pixels (approximately 4 Mpix), whereas the first active region location 504 may be only 50×1200 pixels (60,000 pixels) the second active region location 506 may be only 300×500 pixels (150,000 pixels), and the third active region location 508 may be only 1000×200 pixels (200,000 pixels). The active regions thus account for only 410,000 pixels out of 4 Mpix, or just over 10% of the display area 502. This means that the active region content can potentially be generated, transmitted, and displayed at a small fraction of the computational, power, and transmission bandwidth costs as content rendered over the entire display area 502.

In some examples, the active regions differ from each other with respect to parameters other than location and content. For example, in the illustrated example, the third active region content 520 (the caption text) may be displayed at third active region location 508 at a lower resolution or pixel density than the first active region content 510 and the second active region content 512, such as each pixel encoding the third active region content 520 being mapped to a 2×2 square of pixels of the display area 502 (i.e., mapped at a 1:4 ratio). Thus, instead of including 200,000 pixels of content as in the example above (1000×2000 pixels), the third active region content 520 would only include 50,000 pixels of content (500×1000 pixels) of content at a pixel density of 1:4. In other examples, the third active region content 520 may be mapped to pixels of the display area 502 on a 1:2 (non-square), 1:16 (4×4 square), or other ratio higher than a 1:1 ratio used for the first active region content 510 and the third active region content 520. This mapping may be implemented using macropixels as described above. In some examples, the encoding of the active region data in a transport frame may include an encoding of the parameters governing each active region, such as in a sub-frame header for each active region as described below with reference to FIG. 8 through FIG. 10.

In the illustrated example, the second active object 516 is associated with a location in the 3D physical environment, whereas the first active object 514 and third active object 518 are associated with fixed locations of the display area 502. This means that the second active object 516 may benefit from being refreshed at a high refresh rate (e.g., 120 Hz) to effect motion compensation, whereas the first active object 514 and third active object 518 may not need to be refreshed at a higher refresh rate than the relatively lower frame rate (e.g., 30 Hz). In some examples, different active regions may have their locations in the display area 502 updated at a higher or lower refresh rate than others based on such distinctions, or based on other criteria.

The inactive region 522, as described above, may display only blank or black pixels in some examples. These blank or black pixels may be regarded as content being displayed at a spatiotemporal density of zero (e.g., zero pixels per degree per second). In other examples, content may be displayed in the inactive region 522 of the display area 502 at a lower refresh rate, at a lower pixel density (e.g., using macropixels as described above), at a lower resolution, and/or at a lower frame rate than the active region content 510, 512, 520.

FIG. 6 illustrates a second example display area 610 of a display 106 showing a second active region 606 encompassing multiple overlapping active objects. Specifically, the second active object location 608 of the second active object 516 (i.e., the virtual avatar) overlaps with a fourth active object location 602 of a fourth active object 604 (shown as video content, such as a short film showing video content related to the house being toured). In this example, the active object module 202 may map the 3D location of the virtual avatar (second active object 516) onto the 2D display area 610 and provide the corresponding active object location data, along with active object location data for the video content (fourth active object 604), to the active region module 204. The active region module 204 processes this active object data, determines that the two active objects 516, 604 are overlapping, and as a result generate a single rectangular second active region 606 encompassing the locations of both the second active object 516 and fourth active object 604. This approach may result in some blank portions of the display area 610, such as blank region 612 within the second active region 606, being updated more frequently and/or at a higher pixel density than is required. However, it simplifies the identification and update of active regions when constructing, transmitting, and decoding transport frames, which may result in more efficiencies than inefficiencies relative to a scheme in which each active object occupies a distinct active region. It will be appreciated that some examples may also combine two or more active objects into a single active region if they are adjacent, or nearly adjacent, rather than overlapping.

In this example, the second active region 606 has dimensions defined by the leftmost, rightmost, uppermost, and lowermost points of the set of active objects it encompasses.

FIG. 7 illustrates a third example display area 718 of a display 106 showing active regions expanded based on sectors 702 of the display 106. In this example, the control logic or other hardware of the display 106 is constrained such that pixel density, refresh rate, resolution and/or frame rate of each sector 702 can be controlled independently, but the individual pixels within each sector 702 must all be displayed according to a common pixel density, refresh rate, resolution and/or frame rate. The illustrated example is simplified for visibility; it will be appreciated that, in some examples, a display 106 may include dozens or hundreds of sectors 702 within its display area 718. However, some displays 106 may include an even smaller number of sectors 702 than those of the illustrated example, such as four sectors 702 corresponding to four quadrants of the display area 718.

In some examples using a display 106 having a display area 718 controlled on a per-sector basis as described above, the display 106 may transmit information regarding its sector configuration to the active region rendering system 104, e.g., as display hardware data sent over the communication link 108 to be received and processed by the display capabilities module 210. The active region rendering system 104 may then set an operating mode based on the capabilities of the display 106, and may optionally communicate a confirmation of the operating mode back to the display 106 via the communication link 108, for example, using the output module 208. The selected operating mode may, in some examples, determine the type of transport frame used to transmit the active region data (as detailed below in reference to FIG. 8 through FIG. 11). The communication of display hardware data and optional confirmation by the output module 208 may be referred to as a “handshake”, and in some examples may be performed upon power-on and/or when connecting the display 106 to the computing system 102 via the communication link 108.

In this example, the size of the sectors 702 constrains the segmentation of the display area 718 in accordance with a relatively granular grid. Thus, the second active region location 506 is expanded to occupy four sectors (first sector 704, second sector 706, third sector 708, and fourth sector 710), thereby defining an expanded second active region 712. Similarly, the first active region location 504 is expanded by the active region module 204 to occupy a set of four sectors 702, thereby defining an expanded first active region 716, and the third active region location 508 is expanded to occupy a set of four sectors 702 along the center of the bottom of the display area 718, thereby defining an expanded third active region 714. The content displayed within each active region remains unchanged from the example of FIG. 5: each expanded active region 712, 714, 716 includes a blank portion outside of each respective original active region location, and the original active region content is displayed within the respective original active region location. However, due to the constraints of the display limiting control of spatiotemporal density of information presented to between-sector variation (and not within-sector variation), these blank portions may be displayed and updated at the same spatiotemporal density as the original active region locations.

### Transport Frames

In various examples, the active region data is generated at the computing system 102 and transmitted to the display 106 as a sequence of transport frames generated by the frame generation module 206. Each transport frame corresponds to a frame in a sequence of frames for display within the display area of the display 106, e.g., at a frame rate corresponding to the rate at which new transport frames are received, decoded, and used to present a frame at the display 106. In some examples, a single transport frame can include multiple sub-frames for sequential presentation by the display within the duty cycle of a single frame, e.g., at a refresh rate that is higher than the frame rate. In some examples, the sub-frames can include updated sub-frames for refreshing or updating the locations of active regions without updating the content of those active regions. In some examples, the sub-frames can include color sub-frames for sequential presentation by a color sequential display (also referred to as a field-sequential color system (FSC)).

The number and location of the active regions may change from frame to frame in a sequence of frames to be displayed by the display 106. Accordingly, in various examples described herein, each transport frame reserves a few header pixels at the beginning of each frame as a frame header to encode frame parameters, such as the number of active regions in the frame. The parameters of each active region (such as the active region location and the active region pixel density) are defined by a sub-frame header encoded as several header pixels at the start of the active region. In some examples, the size of each active region is used when the display 106 decodes the transport frame to calculate an offset to the start of the next active region. Thus all active region data (encoded as the sub-frame header encoding the active region location data and a payload encoding the active region content) is abutted adjacent to each other for all of the active regions in the frame. In some examples, an allowance for dummy data is provided for spacing time critical data, as described in greater detail below.

FIG. 8 illustrates a first example transport frame 802 encoding contiguous active region data by color, for decoding and display by a color sequential display. Instead of sending a fixed number of pixels for each row and a fixed number of those rows for each frame, as in a conventional transport frame used in display data transmission, the illustrated example generates and sends a transport frame 802 encoding only the active regions, e.g., only the sub-regions of the display area with active pixels. In the illustrated examples, the shapes of the active regions are rectangular and the size of each active region is a multiple of pixels such that each pixel in the transport frame 802 is mapped to a whole number of pixels of the display 106. This mapping can be determined at least in part, in some examples, by the display capabilities module 210 during the handshake as described above. The position for each rectangular active region is defined by active region location data encoded in the transport frame 802; for example, each active region location may be defined by a horizontal (X) and vertical (Y) offset from the upper left (UL) corner of the display area along with active region dimension information (which may be implicit in the active region content in some examples).

The illustrated example maps pixels of the transport frame 802 to pixels of the display 106 at an integer ratio (which may be different for different active regions) in order to avoid complex scaling or data manipulation. However, it will be appreciated that some examples may enable non-integer ratios, such that a pixel value encoded in the transport frame 802 is mapped to a non-integer number of pixels of the display 106, thereby requiring the determination of display pixel values based on two or more pixel values of the transport frame 802.

Color sequential displays typically require that all of the data for one color be transmitted together to minimize latency and optimize color coherency. Thus, the pixel data from each active region may be separated into its color primary components and packed together in an efficient format, such as those shown in FIG. 8 through FIG. 10.

To fit within existing video protocols, a “transport resolution” may be defined in some examples to pack the encoded data into non-blanking pixels of the transport frame; this may be a traditional fixed H/V resolution. It will be appreciated that these non-blanking pixels are distinguished from the blanking pixels for the purpose of transmitting the encoded and packed image data using existing video protocols; the non-blanking pixels include both header pixels (e.g., encoding active region location data and other parameters) and color packed data pixels (e.g., encoding active region content). The non-blanking pixels of the transport frame are thus not identical to the active pixels of the display area of the display 106.

In accordance with the aspects described above, transport frame 802 encodes three active regions (denoted as active regions 1, 2, and 3), such as the three active regions shown in FIG. 5. Each active region is encoded as three separate color sub-frames (shown as red, green, and blue sub-frames), and each set of color-specific sub-frames is packed together in the transport frame before the next set of color-specific sub-frames. Thus, in order, the transport frame 802 includes a frame header 822 (e.g., encoding frame parameters such as the number of active regions in the frame), a red sub-frame 804 for a first active region, a red sub-frame 806 for a second active region, a red sub-frame 808 for a third active region, a green sub-frame 810 for the first active region, a green sub-frame 812 for the second active region, a green sub-frame 814 for the third active region, a blue sub-frame 816 for the first active region, a blue sub-frame 818 for the second active region, and a blue sub-frame 820 for the third active region. Each color sub-frame begins with a sub-frame header 824 (e.g., encoding active region parameters such as the active region location data, including both location and size data, and a pixel density as indicated by, e.g., a pixel mapping ratio).

After the blue sub-frame 820 for the third active region, the transport frame 802 may, in some examples, fill out the rest of its body with blank or dummy data (such as zero-value data) indicating blank pixels for the remaining portion(s) of the display (e.g., the inactive region(s)), shown as blank portion 826.

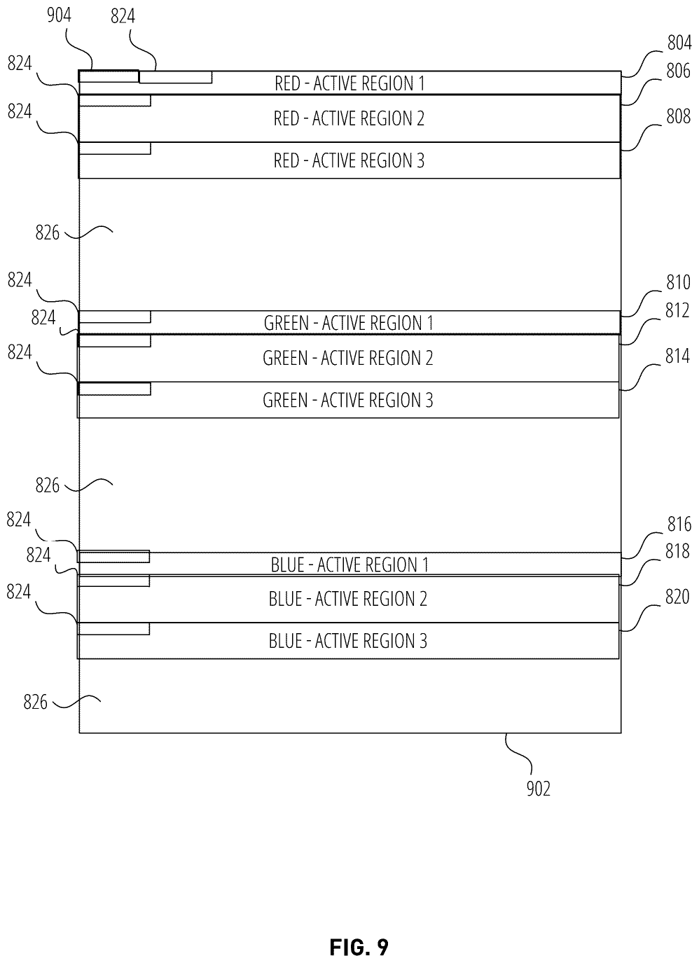

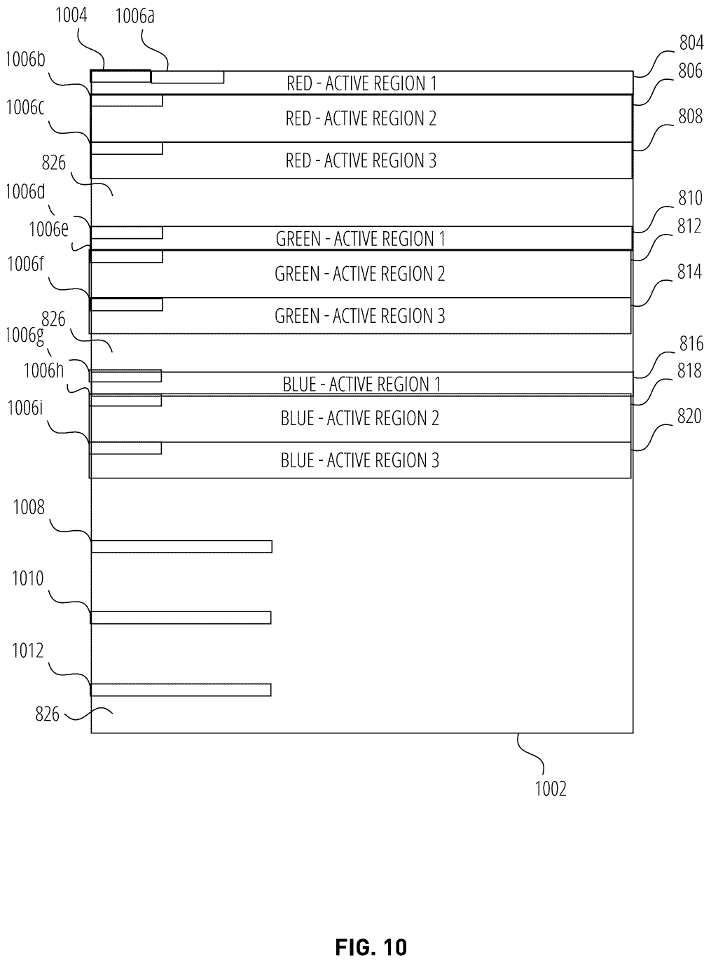

Thus, in the example transport frame 802, the active region data is all transmitted at the beginning of the transport frame 802, even though the frame time is divided temporally into 3 sub-frames. In some examples, this format may introduce latency at the display 106 for rendering some of the color sub-frames. For example, in some examples, the display 106 presents each color at temporally regular intervals within the frame time (e.g., in a frame having a frame rate of 60 HZ and a corresponding frame time of 15 milliseconds, red is displayed beginning at 0 ms from vertical synchronization (VSync) at the beginning of the frame duty cycle, green is displayed beginning at 5 ms from VSync, and blue is displayed beginning at 10 ms from Vsync). In such an example, the blue sub-frames 816, 818, 820 may be received by the display 106 long before they need to be presented on the display 106, potentially requiring the blue sub-frame content to be cached, buffered, or delayed before it can be displayed. Accordingly, further example formats for color sequential transport frames are described and illustrated below at FIG. 9 and FIG. 10.

In some examples, the frame header 822 encodes the number of active regions in the frame and identifiers for each active region, also referred to herein as a region ID. Each sub-frame header encodes the active region location data as the region ID, pixel coordinates for the beginning of the region (e.g., the upper left corner of the region), and a size of the region (e.g., a horizontal pixel width and vertical pixel height). The sub-frame header may also include parameters such as pixel density, refresh rate, etc. The size data (along with the pixel density parameter data) communicates how many pixels to expect in the subsequent sub-frame payload. The size data also communicates where to locate the next region of the frame. The region ID data communicates which content should be used to refresh the region when the region changes location.

FIG. 9 illustrates a second example transport frame 902 encoding spaced apart active region data by color. As in transport frame 802, the transport frame 902 of FIG. 9 includes one color-specific sub-frame for each color of each active region. However, frame header 904 in FIG. 9 may indicate that the transport frame format being used in transport frame 902 accords with the spaced-apart scheme described herein.

The active regions of the transport frame 902 differ from those of transport frame 802 primarily in their location within the transport frame 902: in the illustrated example, they are spaced apart within the transport frame 902 data to be equidistant, thereby potentially addressing the latency issue described in reference to FIG. 8. A blank portion 826 is inserted in between each cluster of color-specific active regions. As described above, in some examples the location of each sub-frame within the transport frame 902 may be indicated by data within each sub-frame header 824, e.g., by indicating the sub-frame position of the immediately subsequent sub-frame within the transport frame 902.

In some examples, the format shown in FIG. 9 may minimize latency for color sequential displays.

FIG. 10 illustrates a third example transport frame 1002 encoding active region data and updated active region location data by color. The format shown in FIG. 10 may enable the feature described above in which active region content is updated at a frame rate lower than the refresh rate of the active region locations. It will be appreciated that the color sequential format shown in FIG. 10 could be adapted to a non-color sequential display with suitable modifications.

The transport frame 1002 includes a frame header 1004 that may encode frame parameters, which in this example may also include information indicating how many active region location updates are encoded into the transport frame 1002: thus, e.g., the frame header 1004 may encode parameters indicating a refresh rate for one or more of the active region in the current frame that is a multiple of the frame rate at which the transport frames 1002 are being received and decoded by the display 106.

The transport frame 1002 also includes three clusters of color-specific sub-frames, as in the transport frame 802 of FIG. 8. However, instead of a uniform blank portion 826 following the three clusters, the transport frame 1002 includes one or more updated sub-frame headers updating the active region location of one or more of the active regions at various temporal points within the frame time. Thus, as shown in FIG. 10, a sequence of updated red sub-frame headers 1008 are included that encode updated active region location data for the red sub-frames 804, 806, 808. The updated red sub-frame headers 1008 thus include updated versions of the sub-frame headers 1006a, 1006b, 1006c for the three red sub-frames 804, 806, 808. The updated red sub-frame headers 1008 are followed by a further blank portion 826, and then a set of updated green sub-frame headers 1010 including updated versions of the sub-frame headers 1006d, 1006c, 1006f for the three green sub-frames 810, 812, 814. The updated green sub-frame headers 1010 are followed by a further blank portion 826, and then a set of updated blue sub-frame headers 1012 including updated versions of the sub-frame headers 1006g, 1006h, 1006i for the three blue sub-frames 816, 818, 820, and finally by a last blank portion 826.

In operation, the color sequential display receives and decodes each cluster of color-specific sub-frames and displays the encoded content of each sub-frame over the corresponding period of the frame time. The color sequential display then receives and decodes each sequence of updated sub-frame headers 1008, 1010, 1012 in order and refreshes the display area at the updated active region locations indicated by the updated sub-frames, using the same active region content encoded at the earlier color-specific sub-frames.

It will be appreciated that the features of the various transport frames described with reference to FIG. 8 through FIG. 10 above may be combined in various sub-combinations in different examples, and may be combined in different configurations with respect to different regions within a given frame, with respect to different frames in a sequence of frames, etc. For example, in some cases a display system may have large number of active regions to update and may split the sub-frames across two or more consecutive frames. In some examples, some active regions within a frame may have higher refresh rates than other active regions within the same frame, such that only the higher refresh rate active regions have updated sub-frame headers in the transport frame as shown in FIG. 10 (e.g., updated red sub-frame headers 1008, updated green sub-frame headers 1010, and updated blue sub-frame headers 1012 may include updated sub-frame headers for only active region 1 and active region 3 but not active region 2, because the refresh rate of active region 2 is lower than for active regions 1 and 3). Similarly, in some examples, a given active region may not change its location within the frame, and the transport frame may accordingly omit updated sub-frame headers for that stationary active region regardless of the refresh rate parameter of the stationary active region. It will be appreciated that other combinations and sub-combinations of the transport frame features described above are contemplated within the scope of this disclosure.

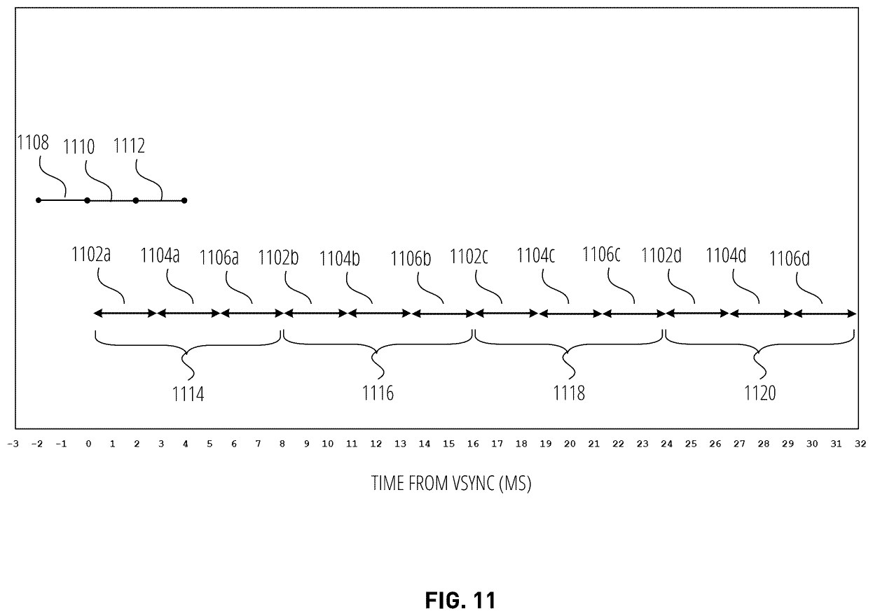

FIG. 11 is a timing diagram of a further transport frame showing the timing of the transmission and presentation of active region content, wherein the active region content is transmitted once and the active region location data is updated four times per color within the frame time of 32 milliseconds (corresponding to a frame rate of roughly 30 Hz). The example shown in FIG. 11 roughly corresponds to transport frame 1002 having the format shown in FIG. 10. The content of the three clusters of color-specific sub-frames is shown as red content 1108, green content 1110, and blue content 1112 in the upper time course, all transmitted near the temporal beginning of the frame time, or even in the latter portions of the previous frame: e.g., in the illustrated example, red content 1108 is transmitted from −2 to 0 ms, green content 1110 from 0 to 2 ms, and blue content 1112 from 2 to 4 ms from VSync at the beginning of the frame time. The display of the various sub-frames is shown in the lower time course: the red sub-frames are first displayed during period 1102a, the green sub-frames are first displayed during period 1104a, and the blue sub-frames are first displayed during period 1106a. This first set of color sub-frames 1102a, 1104a, 1106a are displayed from between about 0 ms to 8 ms from VSync, defining a first refresh period 1114. After this, in accordance with the updated active region data received in the transport frames (e.g., in the updated sub-frame headers 1008, 1010, 1012 of transport frame 1002), the content is displayed again at updated or refreshed locations: the red sub-frames are re-displayed during period 1102b, the green sub-frames are re-displayed during period 1104b, and the blue sub-frames are re-displayed during period 1106b, between about 8 ms and 16 ms from VSync, defining second refresh period 1116. This update cycle repeats itself two more times, over periods 1102c, 1104c, 1106c (third refresh period 1118 at 16-24 ms) and 1102d, 1104d, 1106d (fourth refresh period 1120 at 24-32 ms), for a total of four refresh periods 1114, 1116, 1118, 1120 for each active region over the frame time. In other words, a refresh rate is established for the active region locations that is equal to four times the frame rate at which the active region content is updated. It will be appreciated that this scheme can be dynamically expanded to various data rates, such that a lower data rate for content transmission, and therefore a lower frame rate, can be compensated for by increasing the ratio of refresh rate to frame rate.

In some examples, the time periods at the beginning and ending of the frame time (e.g., between 0 ms and 2 ms and between 30 ms and 32 ms) may be reserved as initialization and/or reset periods, such as ramp-up and/or relax periods for the light source and/or liquid crystal elements of the display 106. In such examples, the refresh periods 1114, 1116, 1118, 1120 can be compressed correspondingly.

In some examples, one or more of the transport frame formats 802, 902, 1002 may be interleaved with each other and/or with different transport frame formats, such as transport frames encoding content for display in inactive regions of the display area. By means of these various formats, and optionally the interleaving or alternation thereof, a system may achieve a widely varying and dynamic configuration of frame rates for content, refresh rates for region locations, and pixel densities for various regions displayed in various regions of the display area over various time periods. For example, some systems may dynamically adjust the frame rate, refresh rate, or pixel density of various display regions based on the capacity of the system and the number, size, and content of the active regions and inactive regions. The frame headers can also include metadata to update various parameters used by the display sequence controller 310 to control the pixel circuits of the display area 304. For example, if the number of regions and/or the identifiers of the regions (e.g., region IDs) change relative to those indicated in the previous transport frame, some parameters used by the display sequence controller 310 may need to be updated in the frame header for the current transport frame.

In some examples, it may be beneficial to use the display to provide a faster refresh rate than the frame rate even without segregation of the display area into active and inactive regions. It will be appreciated that, in some examples, all portions of the display area may be regarded as active regions, or as a single large active region. Such examples can still potentially utilize the techniques described herein to provide a higher refresh rate than the frame rate and thereby assist in motion compensation.

### Machine Architecture

FIG. 12 is a diagrammatic representation of the machine 1200 within which instructions 1202 (e.g., software, a program, an application, an applet, an app, or other executable code) for causing the machine 1200 to perform any one or more of the methodologies discussed herein may be executed. For example, the instructions 1202 may cause the machine 1200 to execute any one or more of the methods described herein. The instructions 1202 transform the general, non-programmed machine 1200 into a particular machine 1200 programmed to carry out the described and illustrated functions in the manner described. The machine 1200 may operate as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch, a pair of augmented reality glasses), a smart home device (e.g., a smart appliance), other smart devices, a web appliance, a network router, a network switch, a network bridge, or any machine capable of executing the instructions 1202, sequentially or otherwise, that specify actions to be taken by the machine 1200. Further, while a single machine 1200 is illustrated, the term “machine” shall also be taken to include a collection of machines that individually or jointly execute the instructions 1202 to perform any one or more of the methodologies discussed herein. In some examples, the machine 1200 may comprise both client and server systems, with certain operations of a particular method or algorithm being performed on the server-side and with certain operations of the particular method or algorithm being performed on the client-side.

The machine 1200 may include processors 1204, memory 1206, and input/output I/O components 1208, which may be configured to communicate with each other via a bus 1210. In an example, the processors 1204 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1212 and a processor 1214 that execute the instructions 1202. The term “processor” is intended to include multi-core processors that may comprise two or more independent processors (sometimes referred to as “cores”) that may execute instructions contemporaneously. Although FIG. 12 shows multiple processors 1204, the machine 1200 may include a single processor with a single-core, a single processor with multiple cores (e.g., a multi-core processor), multiple processors with a single core, multiple processors with multiples cores, or any combination thereof.

The memory 1206 includes a main memory 1216, a static memory 1218, and a storage unit 1220, both accessible to the processors 1204 via the bus 1210. The main memory 1206, the static memory 1218, and storage unit 1220 store the instructions 1202 embodying any one or more of the methodologies or functions described herein. The instructions 1202 may also reside, completely or partially, within the main memory 1216, within the static memory 1218, within machine-readable medium 1222 within the storage unit 1220, within at least one of the processors 1204 (e.g., within the processor's cache memory), or any suitable combination thereof, during execution thereof by the machine 1200.

The I/O components 1208 may include a wide variety of components to receive input, provide output, produce output, transmit information, exchange information, capture measurements, and so on. The specific I/O components 1208 that are included in a particular machine will depend on the type of machine. For example, portable machines such as mobile phones may include a touch input device or other such input mechanisms, while a headless server machine will likely not include such a touch input device. It will be appreciated that the I/O components 1208 may include many other components that are not shown in FIG. 12. In various examples, the I/O components 1208 may include user output components 1224 and user input components 1226. The user output components 1224 may include visual components (e.g., a display such as the display 106, a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1226 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1208 may include biometric components 1228, motion components 1230, environmental components 1232, or position components 1234, among a wide array of other components. For example, the biometric components 1228 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1230 include acceleration sensor components (e.g., accelerometer), gravitation sensor components, rotation sensor components (e.g., gyroscope).

The environmental components 1232 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), depth sensors (such as one or more LIDAR arrays), or other components that may provide indications, measurements, or signals corresponding to a surrounding physical environment.

With respect to cameras, the machine 1200 may have a camera system comprising, for example, front cameras on a front surface of the machine 1200 and rear cameras on a rear surface of the machine 1200. The front cameras may, for example, be used to capture still images and video of a user of the machine 1200 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the machine 1200 may also include a 360° camera for capturing 360° photographs and videos.

Further, the camera system of the machine 1200 may include dual rear cameras (e.g., a primary camera as well as a depth-sensing camera), or even triple, quad or penta rear camera configurations on the front and rear sides of the machine 1200. These multiple cameras systems may include a wide camera, an ultra-wide camera, a telephoto camera, a macro camera, and a depth sensor, for example. The system may additionally include infra-red cameras to permit hand gesture tracking, eye position tracking or night vision, for example.

The position components 1234 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1208 further include communication components 1236 operable to couple the machine 1200 to a network 1238 or devices 1240 via respective coupling or connections. For example, the communication components 1236 may include a network interface component or another suitable device to interface with the network 1238. In further examples, the communication components 1236 may include wired communication components, wireless communication components, cellular communication components, satellite communication, Near Field Communication (NFC) components, Bluetooth® components (e.g., Bluetooth® Low Energy), Wi-Fi® components, Zigbee, Ant+, and other communication components to provide communication via other modalities. The devices 1240 may be another machine or any of a wide variety of peripheral devices (e.g., a peripheral device coupled via a USB).

Moreover, the communication components 1236 may detect identifiers or include components operable to detect identifiers. For example, the communication components 1236 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1236, such as location via Internet Protocol (IP) geolocation, location via Wi-Fi® signal triangulation, location via detecting an NFC beacon signal that may indicate a particular location, and so forth.

The various memories (e.g., main memory 1216, static memory 1218, and memory of the processors 1204) and storage unit 1220 may store one or more sets of instructions and data structures (e.g., software) embodying or used by any one or more of the methodologies or functions described herein. These instructions (e.g., the instructions 1202), when executed by processors 1204, cause various operations to implement the disclosed examples.

The instructions 1202 may be transmitted or received over the network 1238, using a transmission medium, via a network interface device (e.g., a network interface component included in the communication components 1236) and using any one of several well-known transfer protocols (e.g., hypertext transfer protocol (HTTP)). Similarly, the instructions 1202 may be transmitted or received using a transmission medium via a coupling (e.g., a peer-to-peer coupling) to the devices 1240.

### Software Architecture

FIG. 13 is a block diagram 1300 illustrating a software architecture 1302, which can be installed on any one or more of the devices described herein. The software architecture 1302 is supported by hardware such as a machine 1304 that includes processors 1306, memory 1308, and I/O components 1310. In this example, the software architecture 1302 can be conceptualized as a stack of layers, where each layer provides a particular functionality. The software architecture 1302 includes layers such as an operating system 1312, libraries 1314, frameworks 1316, and applications 1318. Operationally, the applications 1318 invoke API calls 1320 through the software stack and receive messages 1322 in response to the API calls 1320. The Computing system 102 and active region rendering system 104 thereof may be implemented by components in one or more layers of the software architecture 1302.

The operating system 1312 manages hardware resources and provides common services. The operating system 1312 includes, for example, a kernel 1324, services 1326, and drivers 1328. The kernel 1324 acts as an abstraction layer between the hardware and the other software layers. For example, the kernel 1324 provides memory management, processor management (e.g., scheduling), component management, networking, and security settings, among other functionalities. The services 1326 can provide other common services for the other software layers. The drivers 1328 are responsible for controlling or interfacing with the underlying hardware. For instance, the drivers 1328 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1314 provide a common low-level infrastructure used by the applications 1318. The libraries 1314 can include system libraries 1330 (e.g., C standard library) that provide functions such as memory allocation functions, string manipulation functions, mathematic functions, and the like. In addition, the libraries 1314 can include API libraries 1332 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1314 can also include a wide variety of other libraries 1334 to provide many other APIs to the applications 1318.

The frameworks 1316 provide a common high-level infrastructure that is used by the applications 1318. For example, the frameworks 1316 provide various graphical user interface (GUI) functions, high-level resource management, and high-level location services. The frameworks 1316 can provide a broad spectrum of other APIs that can be used by the applications 1318, some of which may be specific to a particular operating system or platform.

In an example, the applications 1318 may include a home application 1336, a location application 1338, and a broad assortment of other applications such as a third-party application 1340. The applications 1318 are programs that execute functions defined in the programs. Various programming languages can be employed to create one or more of the applications 1318, structured in a variety of manners, such as object-oriented programming languages (e.g., Objective-C, Java, or C++) or procedural programming languages (e.g., C or assembly language). In a specific example, the third-party application 1340 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1340 can invoke the API calls 1320 provided by the operating system 1312 to facilitate functionalities described herein.

### Conclusion

As described above, examples described herein may address one or more technical problems associated with the computational, power, and data transmission limitations of high-resolution, high frame-rate displays such as head-mounted displays used for VR or AR. By displaying content at a high spatiotemporal density only within the active regions, computational load may be reduced. Second, by displaying content at a high spatiotemporal density only within the active regions, power requirements may be reduced. Third, by displaying content at a high spatiotemporal density only within the active regions, transmission capacity requirements may be reduced. Alternatively, seen from the opposite perspective, the spatiotemporal density (e.g., resolution, pixel density, and/or refresh rate) of the content displayed at the active regions may be increased while staying within the computational, power, and transmission capacity constraints of the system. Thus, in some examples, small regions of virtual content may be displayed at a high refresh rate and a high pixel density, thereby providing a realistic appearance and avoiding artifacts such as motion blur or flicker, even when using a computing system having limited computing, power, and/or data transmission capacities. Further examples described herein may attempt to address one or more additional technical problems, such as constraints imposed by displays controlled on a per-sector basis, minimizing latency between data transmission and display, modifying the pixel density and/or refresh rate of various active regions relative to each other depending on the requirements and parameters of each active region, and various other technical problems as will be appreciated by a skilled person based on the present disclosure.
Thus, in accordance with the examples described herein, example 1 is a method comprising: generating active region data comprising, for each of one or more active regions: active region location data; and active region content; transmitting the active region data to a display having a display area; and for each active region, displaying the active region content at an active region location of the display area based on the active region location data, the active region content being displayed at a higher spatiotemporal information density than content displayed in the display area outside of the active regions.
In Example 2, the subject matter of Example 1 includes, obtaining active object data comprising, for each of one or more active objects: object location data; and object content; and wherein generating the active region data comprises: processing the object location data of the one or more active objects to generate the active region location data of the one or more active regions; and processing the object content of the one or more active objects to generate the active region content of the one or more active regions.
In Example 3, the subject matter of Example 2 includes, wherein: the higher spatiotemporal information density comprises a higher pixel density.
In Example 4, the subject matter of Examples 2-3 includes, wherein: the higher spatiotemporal information density comprises a higher refresh rate.
In Example 5, the subject matter of Example 4 includes, wherein: transmitting the active region data to the display comprises: transmitting a sequence of one or more transport frames, each transport frame corresponding to a respective video frame and comprising: a frame header; and one or more sub-frames, each sub-frame comprising a sub-frame header and a sub-frame payload; wherein: the active region locations in the respective video frame are determined based on the frame header and the sub-frame headers; and the active region content of the one or more active regions in the respective video frame are determined based on the sub-frame payloads.
In Example 6, the subject matter of Example 5 includes, wherein: the display is a color sequential display; and each transport frame comprises, in order: for each active region represented in the transport frame, a first color sub-frame representative of the first color pixel components of the active region; and for each active region represented in the transport frame, a second color sub-frame representative of the second color pixel components of the active region.
In Example 7, the subject matter of Example 6 includes, wherein: each transport frame further comprises, after the second color sub-frames for each active region represented in the transport frame: updated sub-frame headers for the first color sub-frames and second color sub-frames, each updated sub-frame header comprising an updated active region location for an active region represented in the transport frame.
In Example 8, the subject matter of Examples 2-7 includes, wherein: generating the active region data further comprises, for each active region: identifying one or more sectors of the display at least partially overlapping the active region location; expanding the active region location to include the one or more sectors; and generating the active region location data based on the expanded active region location.
Example 9 is a system comprising: a display having a display area; a processor; and a memory storing instructions that, when executed by the processor, configure the system to perform operations comprising: generating active region data comprising, for each of one or more active regions: active region location data; and active region content; transmitting the active region data to the display; for each active region, displaying the active region content at an active region location of the display area based on the active region location data, the active region content being displayed at a higher spatiotemporal information density than content displayed in the display area outside of the active regions.
In Example 10, the subject matter of Example 9 includes, wherein: the operations further comprise: obtaining active object data comprising, for each of one or more active objects: object location data; and object content; and generating the active region data comprises: processing the object location data of the one or more active objects to generate the active region location data of the one or more active regions; and processing the object content of the one or more active objects to generate the active region content of the one or more active regions.
In Example 11, the subject matter of Example 10 includes, wherein: the higher spatiotemporal information density comprises a higher pixel density.
In Example 12, the subject matter of Examples 10-11 includes, wherein: the higher spatiotemporal information density comprises a higher refresh rate.
In Example 13, the subject matter of Example 12 includes, wherein: transmitting the active region data to the display comprises: transmitting a sequence of one or more transport frames, each transport frame corresponding to a respective video frame and comprising: a frame header; and one or more sub-frames, each sub-frame comprising a sub-frame header and a sub-frame payload; wherein: the active region locations in the respective video frame are determined based on the frame header and the sub-frame headers; and the active region content of the one or more active regions in the respective video frame are determined based on the sub-frame payloads.
In Example 14, the subject matter of Example 13 includes, wherein: the display is a color sequential display; and each transport frame comprises, in order: for each active region represented in the transport frame, a first color sub-frame representative of the first color pixel components of the active region; and for each active region represented in the transport frame, a second color sub-frame representative of the second color pixel components of the active region.
In Example 15, the subject matter of Example 14 includes, wherein: each transport frame further comprises, after the second color sub-frames for each active region represented in the transport frame: updated sub-frame headers for the first color sub-frames and second color sub-frames, each updated sub-frame header comprising an updated active region location for an active region represented in the transport frame.
In Example 16, the subject matter of Examples 10-15 includes, wherein: the one or more active regions are rectangular.
In Example 17, the subject matter of Example 16 includes, wherein: the one or more active objects comprise at least two active objects; and a first active region location of the display area encompasses at least two active object locations based on the object location data of the at least two active objects.
In Example 18, the subject matter of Examples 10-17 includes, wherein: generating the active region data further comprises, for each active region: identifying one or more sectors of the display at least partially overlapping the active region location; expanding the active region location to include the one or more sectors; and generating the active region location data based on the expanded active region location.
In Example 19, the subject matter of Example 18 includes, wherein: the one or more sectors of the display are identified using display hardware data received from the display.
Example 20 is a non-transitory computer-readable storage medium, the computer-readable storage medium including instructions that, when executed by a computer, cause the computer to: generate active region data comprising: for each of one or more active regions: active region location data; and active region content; transmit the active region data to a display having a display area; and for each active region, display the active region content at an active region location of the display area based on the active region location data, the active region content being displayed at a higher spatiotemporal information density than content displayed in the display area outside of the active regions.
Example 21 is at least one machine-readable medium including instructions that, when executed by processing circuitry, cause the processing circuitry to perform operations to implement of any of Examples 1-20.
Example 22 is an apparatus comprising means to implement of any of Examples 1-20.
Example 23 is a system to implement of any of Examples 1-20.
Example 24 is a method to implement of any of Examples 1-20.

It will be appreciated that the various aspects of the examples described above may be combined in various combination or sub-combinations.

### Glossary

“Augmented reality” (AR) refers, for example, to an interactive experience of a real-world environment where physical objects that reside in the real-world are “augmented” or enhanced by computer-generated digital content (also referred to as virtual content or synthetic content). AR can also refer to a system that enables a combination of real and virtual worlds, real-time interaction, and 3D registration of virtual and real objects. A user of an AR system perceives virtual content that appear to be attached to or interact with a real-world physical object.

“2D” refers to two-dimensional objects or spaces. Data may be referred to as 2D if it represents real-world or virtual objects in two-dimensional spatial terms. A 2D object can be a 2D projection or transformation of a 3D object, and a 2D space can be a projection or transformation of a 3D space into two dimensions.

“3D” refers to three-dimensional objects or spaces. Data may be referred to as 3D if it represents real-world or virtual objects in three-dimensional spatial terms. A 3D object can be a 3D projection or transformation of a 2D object, and a 3D space can be a projection or transformation of a 2D space into three dimensions.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute cither software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Programming Interface (API)). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; USB flash drives; and CD-ROM and DVD-ROM disks. The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” refers, for example, to a device accessed, controlled or owned by a user and with which the user interacts perform an action, or an interaction with other users or computer systems.

What is claimed is:

1. A method comprising:
generating active region data comprising, for each of one or more active regions:
active region location data; and
active region content;
transmitting the active region data to a display having a display area; and
for each active region, displaying the active region content at an active region location of the display area based on the active region location data, the active region content being displayed at a higher spatiotemporal information density than content displayed in the display area outside of the active regions.

2. The method of claim 1,
further comprising:
obtaining active object data comprising, for each of one or more active objects:
object location data; and
object content; and
wherein generating the active region data comprises:
processing the object location data of the one or more active objects to generate the active region location data of the one or more active regions; and
processing the object content of the one or more active objects to generate the active region content of the one or more active regions.

3. The method of claim 2, wherein:
the higher spatiotemporal information density comprises a higher pixel density.

4. The method of claim 2, wherein:
the higher spatiotemporal information density comprises a higher refresh rate.

5. The method of claim 4, wherein:
transmitting the active region data to the display comprises:
transmitting a sequence of one or more transport frames, each transport frame corresponding to a respective video frame and comprising:
a frame header; and
one or more sub-frames, each sub-frame comprising a sub-frame header and a sub-frame payload;
wherein:
the active region locations in the respective video frame are determined based on the frame header and the sub-frame headers; and
the active region content of the one or more active regions in the respective video frame are determined based on the sub-frame payloads.

6. The method of claim 5, wherein:
the display is a color sequential display; and
each transport frame comprises, in order:
for each active region represented in the transport frame, a first color sub-frame representative of first color pixel components of the active region; and
for each active region represented in the transport frame, a second color sub-frame representative of second color pixel components of the active region.

7. The method of claim 6, wherein:
each transport frame further comprises, after the second color sub-frames for each active region represented in the transport frame:
updated sub-frame headers for the first color sub-frames and second color sub-frames, each updated sub-frame header comprising an updated active region location for an active region represented in the transport frame.

8. The method of claim 2, wherein:
generating the active region data further comprises, for each active region:
identifying one or more sectors of the display at least partially overlapping the active region location;
expanding the active region location to include the one or more sectors; and
generating the active region location data based on the expanded active region location.

9. A system comprising:
a display having a display area;
a processor; and
a memory storing instructions that, when executed by the processor, configure the system to perform operations comprising:
generating active region data comprising, for each of one or more active regions:
active region location data; and
active region content;
transmitting the active region data to the display;
for each active region, displaying the active region content at an active region location of the display area based on the active region location data, the active region content being displayed at a higher spatiotemporal information density than content displayed in the display area outside of the active regions.

10. The system of claim 9, wherein:
the operations further comprise:
obtaining active object data comprising, for each of one or more active objects:
object location data; and
object content; and
generating the active region data comprises:
processing the object location data of the one or more active objects to generate the active region location data of the one or more active regions; and
processing the object content of the one or more active objects to generate the active region content of the one or more active regions.

11. The system of claim 10, wherein:
the higher spatiotemporal information density comprises a higher pixel density.

12. The system of claim 10, wherein:
the higher spatiotemporal information density comprises a higher refresh rate.

13. The system of claim 12, wherein:
transmitting the active region data to the display comprises:
transmitting a sequence of one or more transport frames, each transport frame corresponding to a respective video frame and comprising:
a frame header; and
one or more sub-frames, each sub-frame comprising a sub-frame header and a sub-frame payload;
wherein:
the active region locations in the respective video frame are determined based on the frame header and the sub-frame headers; and
the active region content of the one or more active regions in the respective video frame are determined based on the sub-frame payloads.

14. The system of claim 13, wherein:
the display is a color sequential display; and
each transport frame comprises, in order:
for each active region represented in the transport frame, a first color sub-frame representative of first color pixel components of the active region; and
for each active region represented in the transport frame, a second color sub-frame representative of second color pixel components of the active region.

15. The system of claim 14, wherein:
each transport frame further comprises, after the second color sub-frames for each active region represented in the transport frame:
updated sub-frame headers for the first color sub-frames and second color sub-frames, each updated sub-frame header comprising an updated active region location for an active region represented in the transport frame.

16. The system of claim 10, wherein:
the one or more active regions are rectangular.

17. The system of claim 16, wherein:
the one or more active objects comprise at least two active objects; and
a first active region location of the display area encompasses at least two active object locations based on the object location data of the at least two active objects.

18. The system of claim 10, wherein:
generating the active region data further comprises, for each active region:
identifying one or more sectors of the display at least partially overlapping the active region location;
expanding the active region location to include the one or more sectors; and
generating the active region location data based on the expanded active region location.

19. The system of claim 18, wherein:
the one or more sectors of the display are identified using display hardware data received from the display.

20. A non-transitory computer-readable storage medium, the computer-readable storage medium including instructions that, when executed by a computer, cause the computer to:
generate active region data comprising:
for each of one or more active regions:
active region location data; and
active region content;
transmit the active region data to a display having a display area; and
for each active region, display the active region content at an active region location of the display area based on the active region location data, the active region content being displayed at a higher spatiotemporal information density than content displayed in the display area outside of the active regions.
